(19) United States
(12) Patent Application Publication
(10) Pub. No.: US 2026/0266771 A1
(43) Pub. Date: Sep. 10, 2026

(54) MEMS-BASED FLUID SENSOR HAVING VERTICALLY SPACED THERMAL STRUCTURES

(71) Applicant: Hahn-Schickard-Gesellschaft für angewandte Forschung e. V., Stuttgart (DE)

(72) Inventors: Alfons Dehé, Reutlingen (DE); Akash Gupta, Villingen-Schwenningen (DE)

(21) Appl. No.: 19/162,887

(22) PCT Filed: Mar. 6, 2024
(86) PCT No.: PCT/EP2024/055839

§ 371 Date: Sep. 5, 2025

(30) Foreign Application Priority Data
Mar. 6, 2023 (EP) 23160254.1

(51) Int. Cl. G01N 29/24

(52) U.S. Cl. CPC G01N 29/2425

(57) ABSTRACT

The invention relates to a thermal fluid sensor comprising a membrane which exhibits an aperture, a heating element and a temperature sensor. The heating element and the temperature sensor are positioned such that at least one property of a fluid flowing through the aperture can be measured based on the modulation of a heat flow between the heating element and the temperature sensor. The thermal fluid sensor exhibits a support structure which extends at least partially over the aperture at a vertical distance from the membrane, wherein the temperature sensor or the heating element is mounted on the support structure.

In addition, the invention relates to a method for producing the thermal fluid sensor and a use of the thermal fluid sensor for measuring one or more properties of the fluid.

The invention relates to a thermal fluid sensor comprising a membrane which exhibits an aperture, a heating element and a temperature sensor. The heating element and the temperature sensor are positioned such that at least one property of a fluid flowing through the aperture can be measured based on the modulation of a heat flow between the heating element and the temperature sensor. The thermal fluid sensor exhibits a support structure which extends at least partially over the aperture at a vertical distance from the membrane, wherein the temperature sensor or the heating element is mounted on the support structure.

In addition, the invention relates to a method for producing the thermal fluid sensor and to a use of the thermal fluid sensor for measuring one or more properties of the fluid.

### BACKGROUND AND PRIOR ART

Today, microsystems technology is used in many areas of application for the production of compact, electromechanical devices. The microelectromechanical systems (MEMS) that can be produced in this way are very compact (in the micrometer range) with outstanding functionality and ever decreasing manufacturing costs.

MEMS technologies offer a variety of mechanisms for actuation or sensor technology. MEMS-technology structures and components can also be used for temperature measurement. Temperature measurement can also be used to infer the properties of a flowing fluid. A MEMS-based component that can be used to draw conclusions about fluid properties by means of temperature measurements is described below by the term thermal fluid sensor, thermal flux sensor or thermal flow sensor.

Depending on the basic physical principle, thermal fluid sensors can be divided into different categories. Thermoresistive sensors use resistance elements for thermal detection. Thermoelectric sensors detect thermal changes by means of thermopiles. In contrast, diodes and transistor elements are used in thermoelectric sensors. Changes in the resonant frequency in mechanical structures due to temperature-induced stresses are used for frequency-based sensors (see Kuo, Yu & Meng (2012)).

Thermal fluid sensors can be used in a variety of applications, for example to detect gases or as a microphone.

WO 2021/038099 A1 discloses a photoacoustic gas sensor which, in addition to the components commonly used in the prior art to utilize the photoacoustic effect for gas detection, also exhibits a sensor based on a thermal operating principle. The sensor can comprise a heating element, for example a heating resistor, and a thermopile and is preferably present on a separating membrane with at least one aperture, which is located between a detection chamber and reference chamber of the gas sensor. Due to modulation of the heat transfer between the heating element and the temperature sensor as a result of the generated photoacoustic pressure (dependent on the gas concentration), a flow occurs via the perforations, which modulates the heat transfer between the heating element and the sensor. A photoacoustic signal can therefore be detected via the modulation of the heat transfer.

WO 2019/135004 A1 discloses a gas sensor which exhibits a membrane, a heating element and at least two temperature sensors. The membrane extends along a frame which constitutes a carrier material. Furthermore, the membrane exhibits at least two interruption areas. The heating element is arranged on the membrane between the at least two interruption areas. The temperature sensors are located at least partially on the membrane on opposite sides of the heating element. The gas to be analyzed flows through the interruption areas such that gas-specific heat can flow from the heating element to the temperature sensors. The properties of the gas can be detected based on the transit times of a heat transfer through the gas between the heating element and a temperature sensor.

Xu et al. (2022) disclose a sensor in a monolithic structure that can detect the sonic velocity of particles or flows based on the measured temperature difference between closely spaced heating wires. For this purpose, heating wires distributed in a plane are arranged with an acoustically transparent heat sink. The acoustically transparent heat sink may be present in the form of a grid. Four sensor arrays comprising a heating element and two detectors are placed along a plane on a silicon nitride membrane.

A flow sensor is known from the publication JPH 08320245 A, which is able to measure a flow rate and flow velocity of a fluid in a pipeline. For this purpose, the flow sensor comprises a heater and two temperature sensors. While one of the two temperature sensors is exposed to the fluid flow in the pipe, the other temperature sensor is to be protected from the fluid flow. For this purpose, the flow sensor comprises a first substrate and a second substrate, which are positioned one above the other such that the second substrate is present above the first substrate. The heater is located on an intermediate layer, which is arranged between the first substrate and the second substrate. The intermediate layer can be provided by an oxynitride film. The temperature sensors are each present on a further oxynitride film, which extends above the second substrate and below the first substrate. Only the upper temperature sensor is exposed to the fluid flow, while the lower temperature sensor is present in a cavity protected from the fluid flow, which is formed by a substrate. Holes are present in the oxynitride film such that the fluid to be measured can pass through the holes equally to both temperature sensors and the heater. The flow sensor of JPH 08320245 is intended to make it possible to measure a flow rate and flow velocity of the fluid in a pipeline. The measurement of the properties of a fluid flowing through the flow sensor or an aperture of the flow sensor is not disclosed.

The known thermal fluid sensors are characterized by their ease of processing, compact structure and functionality. However, there is also a need for improvement. In particular, known arrangements can entail inefficient heat conduction from the heating element to the temperature sensor, especially due to the arrangement of the components on the membrane and/or the design of the membrane, and associated losses in the accuracy of the measurement results. The reduction or avoidance of measurement noise and an increase in sensitivity would also be desirable. In addition, given the broad sphere of application of thermal fluid sensors, there is also a desire for progressive miniaturization of the sensors.

### Objective of the Invention

The objective of the invention is to provide a thermal fluid sensor or a method for its production which eliminates the disadvantages of the prior art. In particular, one objective of the invention is to provide a thermal fluid sensor which is characterized by reliable functionality and high degree of measurement accuracy in a compact design.

### SUMMARY OF THE INVENTION

The objective according to the invention is solved by the independent claims. Preferred embodiments of the invention are described in the dependent claims.

In a first aspect, the invention relates to a thermal fluid sensor comprising a membrane with an aperture, a heating element and a temperature sensor, which are positioned such that at least one property of a fluid flowing through the aperture can be measured based on the modulation of a heat flow between the heating element and the temperature sensor, wherein the thermal fluid sensor exhibits a support structure which extends at least partially over the aperture at a vertical distance from the membrane, wherein the temperature sensor or the heating element is mounted on the support structure.

Preferably, the heating element and the temperature sensor in the thermal fluid sensor are vertically spaced from one another, wherein preferably one component is mounted on the membrane and the other component is mounted on the support structure. Preferably, the thermal fluid sensor is thus characterized in that the temperature sensor is mounted on the support structure while the heating element is mounted on the membrane or in that the temperature sensor is mounted on the membrane while the heating element is mounted on the support structure.

The thermal fluid sensor according to the invention has proven to be advantageous in a number of aspects.

In particular, the arrangement according to the invention can effectively reduce measurement noise. In known thermal fluid sensors of the prior art, the arrangement of the temperature sensor and heating element on one plane can entail a not insignificant heat transfer due to material-bound heat conduction. The sensitivity of a preferred thermal fluid sensor, on the other hand, is based on heat transfer by convection via the fluid to be analyzed flowing between the temperature sensor and heating element. In other words, the heat flow between the heating element and the temperature sensor is modulated by the fluid (to be analyzed), such that the properties of the fluid can be determined based on the measurable influence of the fluid on the heat flow. For example, heat transfer by convection is advantageously dependent on the properties of the fluid to be analyzed, such that conclusions can be drawn about flow parameters, pressure fluctuation(s), composition and/or concentration of the fluid, for example, based on the modulation of the heat transfer.

In contrast, heat conduction in the plane, for example via a membrane on which the temperature sensor and the heating element are arranged, results in a heat transfer that is not dependent on the properties of the fluid to be analyzed. Changes in the thermal conductivity of the membrane or other materials or components of the sensor therefore lead to heat modulation between the temperature sensor and the heating element which is not dependent on the properties of the fluid, but is reflected in the measurement results as noise. In particular, heat conduction via the membrane results in a higher temperature at the temperature sensor, which increases the thermal noise at the output signal, as this scales proportionally to the root of the temperature.

According to the invention, this disadvantageous effect of the prior art is eliminated such that heat conduction in the plane is reduced between the heating element and the temperature sensor by placing the heating element or the temperature sensor on a support structure, thereby creating a vertical displacement between the heating element and the temperature sensor.

This arrangement can advantageously ensure that heat is transferred from the heating element to the temperature sensor substantially by convection via the fluid to be analyzed. The heat modulation therefore reflects properties of the fluid to be analyzed (flow parameters, pressure fluctuation, heat conduction, etc.). Noise caused by material-bound heat conduction that is independent of the properties of the fluid is advantageously reduced.

A further advantage of the thermal fluid sensor according to the invention is that it enables a particularly controlled modulation of the heat flow, which is transferred from the heating element to the temperature sensor. In particular, the support structure, which extends at least partially at a vertical distance across the aperture of the membrane, allows a particularly small cross-section to be achieved in the form of a channel for one flow direction of the fluid through the thermal fluid sensor. The modulation of the heat flow is dependent on the configuration of the channel. However, the support structure advantageously makes it possible to configure a fluidic resistance for the fluid flowing due to the heat flow. This means that an acoustic resistance for the sound pressure waves can be advantageously configured, particularly in the case of an oscillating fluid flow. Depending on the application, a desired measurement sensitivity or acoustic properties of the fluid sensor can therefore be easily configured. Advantageously, it is also easily possible to amplify a signal by attaching a plurality of temperature sensors. For this purpose, the channel can be provided, on the sides of which temperature sensors and/or heating elements can be arranged, for example, in series. The support structure also advantageously enables a small cross-section of the channel for such a geometry, in which the vertical distance of the support structure above the membrane is configured accordingly.

The channel refers preferably to a spatial section that determines the flow behavior of the fluid between a section of the support structure and the membrane or a heating element or temperature sensor installed thereon. The channel is formed in particular by a vertical extension of the support structure above the membrane (or a temperature sensor or heating element installed thereon). The configuration of the channel is therefore determined in particular by the dimensions of the support structure in relation to the membrane below it (or a temperature sensor or heating element installed on it). The heat flow from the heating element to the temperature sensor passes through the channel, such that the modulation of the heat flow of the fluid is dependent on the flow behavior in the channel formed.

Advantageously, the configuration of the support structure allows the height of the channel to be set to almost any height, for example less than 10 μm, 5 μm, 1 μm, 500 nm, 400 nm, 300 nm, 200 nm, 100 nm or 50 nm. The height of the channel preferably refers to the lowest height or lowest vertical extent of a flow section within the thermal fluid sensor which is preferably present between a temperature sensor or heating element installed on the membrane and a support structure extending above it.

The advantage of this is that a particularly compact fluid sensor can be provided, which is also characterized by excellent measurement properties.

The possibility of sensitive measurements and a higher resolution results, inter alia, from higher flow velocities of the fluid in the area of the heat path between the temperature sensor and the heating element, which are made possible by the configuration of the support structure or by configuring a channel with a low height. This allows the properties of the fluid, such as its flow velocity, to be determined with particularly high precision. Advantageously, particularly small pressure differences can also be detected in this way, such that the sensor has an excellent capacity for acoustic measurements as a sound detector, for example in a photoacoustic gas sensor.

In particular, a high degree of acoustic resistance can also be advantageously configured for dynamic measurements of pressure fluctuations by a low height of the channel. This allows the measuring range to be extended with regard to low cutoff frequencies, or a lower rear volume to be provided for the desired measuring frequencies.

For the acoustic resistance, the relationship

$${R}_{S} ∼ h / ( {lw}^{3} ) \qquad ( 1 )$$

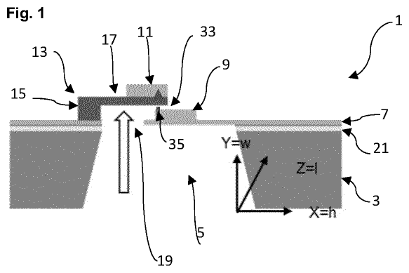

(see Lauwers, Glière & Basrour (2020)) is known, wherein R_{S} denotes the acoustic resistance, h the length, I the width and w the height, wherein w indicates the channel height between the temperature sensor or heating element and the support structure (see FIG. 1).

Advantageously, the configuration of the support structure enables a particularly low height to be achieved and thus a particularly high acoustic resistance due to the antiproportional relationship between R_{S} and w³.

In view of the high acoustic resistance that can be achieved, a lower rear volume can be advantageously provided for dynamic measurements of pressure fluctuations at relatively low frequencies, as can be seen from the following explanations.

The following relationship applies to the rear volume V

$${C}_{bv} = V / ( γ {P}_{0} ) , \qquad ( 2 )$$

wherein C_{bv} is the acoustic compliance or capacity, γ is the adiabatic coefficient of the fluid and P₀ is the static pressure of the fluid, which is usually 1 atm (physical unit atmosphere).

The following applies to a lower acoustic cutoff frequency ω

$$ω = 1 / ( {R}_{S} {C}_{bv} ) . \qquad ( 3 )$$

The capacitance C_{bv} corresponds to a rear volume, which is provided by a spatial section between the carrier and a cover. The acoustic resistance R_{S} can advantageously be set particularly high by a small distance w (see equation (1)). In this way, a particularly low lower cutoff frequency can be advantageously ensured even with relatively small rear volumes, whereby the acoustic resistance is set sufficiently high.

A lower cutoff frequency preferably refers to a frequency below which the thermal fluid sensor can measure properties of the fluid with reduced sensitivity(S) in the event of dynamic pressure fluctuations.

As explained above, the lower cutoff frequency is determined in particular by the acoustic or fluidic resistance, the capacitance and the rear volume. The provision of a support structure to form a channel of a preferred low height allows a low lower cutoff frequency with a compact design.

An upper cutoff frequency preferably characterizes a frequency above which the thermal fluid sensor measures properties of the fluid with reduced sensitivity in the event of dynamic pressure fluctuations. The upper cutoff frequency is influenced, for example, by a heat capacity of the temperature sensor or a thermal resistance of the membrane. Thus, at high frequencies of pressure fluctuations and a correspondingly quickly fluctuating heat modulation, the temperature sensor can reach a metrological limit at which it no longer detects the modulation. It should be noted in this regard that the modulation of the heat flow occurs at a higher frequency, preferably twice as high as the frequency of an acoustic signal. This is due in particular to the fact that the temperature sensor detects a lower temperature both in a positive pressure cycle (in the event of a pressure increase) and in a low pressure cycle (in the event of a pressure decrease), due to a corresponding modulation of the heat flow.

By providing a miniaturized temperature sensor and a thermally insulating support structure, high upper cutoff frequencies can also be advantageously achieved.

As a result, the fluid sensor described can preferably achieve both a particularly low lower cutoff frequency and a high upper cutoff frequency, such that a broad frequency band is achieved in which the thermal fluid sensor can reliably measure pressure fluctuations and thus also sound waves (particularly with regard to audio applications).

Furthermore, the support structure enables a particularly close arrangement between the temperature sensor and the heating element. Due to the close positioning, energy-saving operation of the thermal fluid sensor is advantageously enabled, as operation of the heating element with lower power/lower temperature also provides good measurement results due to the proximity to the temperature sensor.

Preferably, the thermal fluid sensor is a thermal MEMS fluid sensor, wherein this is based on MEMS technology and its sensory structures at least partially exhibit dimensions in the micrometer range (1 μm to 1000 μm). Preferably, for example, the heating element, the temperature sensor, the support structure, the membrane or the formed channel can exhibit a height, width and/or length in the range of less than 1000 μm. It may also be preferred, for example, that only the height of the channel is less than 1000 μm, while the width of the channel, for example, exhibits a larger dimension.

Furthermore, the thermal fluid sensor according to the invention can preferably be produced in a particularly process-efficient manner. Preferably, the thermal fluid sensor according to the invention can be produced using means and process steps from semiconductor systems and/or microsystems, which have proven to be effective in the prior art, ensure fast and simple processing and are suitable for mass production. To produce the thermal fluid sensor, for example, it may be preferable to provide the membrane with the aperture and support structure in one (semiconductor) process. This further simplifies and reduces the cost of production, such that a compact and robust thermal fluid sensor can be provided at low cost.

For the purposes of the invention, a thermal fluid sensor refers to a sensor that is capable of measuring parameters of a fluid flowing between the heating element and the temperature sensor based on the modulation of heat or of a heat flow. In other words, a thermal fluid sensor takes advantage of the fact that, based on the modulation of the heat flow between the heating element and the temperature sensor, it is possible to infer properties of the fluid flowing between these components.

The heat flow refers to the heat as such that emanates from the heating element and is transferred to the temperature sensor. It is known to the person skilled in the art that heat in itself is a form of energy. The fluid that flows between the temperature sensor and the heating element and thus through the heat flow influences the heat flow. This influence and the associated change in the heat flow through the fluid can be detected by the temperature sensor, wherein the change in the heat flow in the context of the invention is referred to as modulation of the heat flow. From a structural point of view, the thermal fluid sensor comprises the components essential for its functionality, comprising a membrane with an aperture, a heating element, a temperature sensor and a support structure. It may also be preferred that the thermal fluid sensor exhibits other components.

The membrane exhibits an aperture through which the fluid flows to the heat flow, wherein the heat flow is given between the heating element and the temperature sensor. Consequently, the aperture of the membrane preferably enables a fluid to pass from a cavity of the carrier into the channel in the direction of the heat flow. The cavity of the carrier refers to a recess in the carrier. The cavity of the carrier is located in a front-side volume. The membrane therefore separates the front volume from a rear volume. The rear volume preferably refers to a spatial section that the fluid reaches after it enters the channel from the opening of the membrane and then passes through the heat flow. A rear volume in the sense of a MEMS microphone can be made possible by a rear cover that is attached to the carrier above the membrane. The rear volume can also have no boundary.

The aperture preferably refers to an opening made in the membrane. The preferred carrier comprises, for example, two or more lateral regions between which the membrane is arranged. The membrane itself can preferably be applied to a sacrificial layer which is coated on the carrier. The thickness of the sacrificial layer on which the membrane is coated can be used to regulate the shape of the channel provided by the support structure. Furthermore, the temperature sensor or the heating element is preferably located on the membrane, whereas the respective other components are located on the support structure. If the heating element is mounted on the support structure, the temperature sensor is located on the membrane. If the temperature sensor is located on the support structure, the heating element is located on the membrane.

The support structure preferably refers to a component of the thermal fluid sensor according to the invention to which the temperature sensor or the heating element is attached. Structurally, the support structure is configured in such a way that it extends at least partially over the aperture at a vertical distance from the membrane. For example, the support structure can exhibit a base and a longitudinal section for this purpose, wherein the longitudinal section preferably runs parallel to the membrane and is arranged at a vertical distance above it. In the context of the invention, the support structure can be used to specify a vertical distance between the temperature sensor and the heating element, wherein the vertical distance can be adjusted, for example, via the height of the base. In addition to the vertical distance or vertical displacement between the heating element and the temperature sensor, an additional lateral distance may be preferred. As will be explained in more detail below, a lateral distance can be used to set a sensitivity, for example, by adjusting a heat path for the heat flow.

By arranging the temperature sensor or the heating element on the support structure and membrane with vertical separation, heat conduction between the two components via the membrane can be advantageously reduced. This makes it possible for heat to be transferred substantially by convection, while at the same time avoiding or reducing heat losses through heat conduction (through the membrane). The support structure can therefore also be regarded as a spacer or an insulating element, which on the one hand reduces heat conduction and on the other hand enables an advantageous configuration of a channel with almost any desired low height (and therefore high acoustic resistance) when the fluid flows through the heat flow.

In the context of the invention, the fluid preferably means a substance that can continuously change shape due to the effect of shear forces. The fluid is therefore in particular a gas or a liquid that can flow through the thermal fluid sensor and thus be measured. Since the influence of the fluid on the heat flow allows conclusions to be drawn about the fluid properties, the thermal fluid sensor according to the invention can also be understood as a liquid sensor or gas sensor, depending on the phase in which the fluid is present.

In a further preferred embodiment, the thermal fluid sensor is characterized in that the at least one property of the fluid flowing through the aperture, which can be measured based on the modulation of a heat flow between the heating element and the temperature sensor, is a flow parameter, a pressure fluctuation, a composition and/or concentration of the fluid.

Consequently, the preferred thermal fluid sensor can advantageously be used to measure a large number of fluid properties, which opens up a wide range of applications.

In a preferred embodiment, a flow parameter can be measured based on the modulation of the heat flow between the heating element and the temperature sensor. Preferably, a flow parameter is selected from a group comprising a flow velocity, a pressure, a volume flow and/or a flow frequency (in the case of an oscillating flow) of the fluid.

The heating element can preferably be configured to emit a constant heat output and thus a fixed heat flow at a constant heating temperature, such that the temperature sensor detects a measuring temperature. The heat flow is modulated by the effect of the fluid, resulting in a change in the measuring temperature measured at the temperature sensor. The change in the measuring temperature can be detected by the temperature sensor. In other words, the modulation of the heat flow is detected by a change in the measuring temperature at the temperature sensor. The higher the flow velocity of the fluid, for example, the lower the measurable temperature. In other words, if the flow velocity is high, the difference from the base temperature is greater than if the flow velocity is lower. The flow velocity can be inferred from the difference between the base temperature and the measured temperature.

It may also be preferred, for example, for the fluid sensor to be regulated to a constant measuring temperature at the temperature sensor. In this case, the heating element is preferably configured such that it emits heat which ensures a constant measuring temperature at the temperature sensor. The effect of the fluid causes modulation of the heat flow. However, a control signal for the heating element can be used to regulate the heat output or heating temperature in such a way that the heat modulation is balanced out and a constant heat transfer to the temperature sensor takes place such that the measuring temperature at the temperature sensor is kept constant. The modulation of the heat is therefore detected by the required regulation of the heating element. If the flow velocity is high, the control signal for providing the heat flow from the heating element must be intensified in order to maintain a constant heat transfer.

The pressure and thus also pressure fluctuations of the fluid flowing through the heat flow can also be measured in the two example ways. The higher the pressure or pressure fluctuations, the higher the modulation of the heat flow.

Balakrishnan et al. (2017) discloses the relationship

$$P / Δ T = A + B \sqrt{u} \qquad ( 4 )$$

wherein A and B are material-dependent constants, P is the pressure of the fluid, ΔT is the temperature difference due to the effect of the fluid and u is the flow velocity. This shows that a higher pressure causes a greater difference in heat flow.

The pressure or the fluid can also spread through the heat flow due to pressure fluctuations through the thermal fluid sensor. Since pressure fluctuations of an elastic fluid represent sound waves, it is therefore also possible to detect sound pressure waves using the preferred thermal fluid sensor. As disclosed in more detail elsewhere herein, the preferred thermal fluid sensor can therefore also be used advantageously as a microphone. The composition and/or concentration of the fluid flowing through the heat flow can also be measured by means of the preferred thermal fluid sensor. This can preferably be done in the context of photoacoustic spectroscopy. For example, pressure fluctuations caused by a photoacoustic effect based on the detection of a certain fluid and/or its detected concentration can be recognized by the modulation of the heat flow.

In a further preferred embodiment, the thermal fluid sensor is characterized in that a channel is formed between the heating element and the temperature sensor by a section of the support structure and the membrane, wherein a flow path for the fluid can be provided through the channel. In other words, a channel is preferably formed between the heating element and the temperature sensor by a section of the support structure and the membrane, wherein the channel defines the flow path for the fluid.

The channel preferably designates a spatial section between the temperature sensor or heating element on the membrane and the longitudinal section of the support structure, through which the fluid flows after it has entered through the aperture. The channel is defined in particular by the support structure, which extends vertically over the membrane. The channel is also determined by the configuration of the temperature sensor or heating element attached to the membrane. Furthermore, the thickness of sacrificial layers, for example between the carrier and the membrane, can also influence the configuration of the channel, as these can reduce the distance between the membrane and the support structure.

By attaching the support structure, it is possible to provide a flow section for the fluid through the thermal fluid sensor, wherein in particular a channel is formed in the flow section between a region of the support structure (for example a longitudinal section) and the membrane or components installed thereon. The channel is present in particular in the region of the flow section of the fluid through which the heat flow is transferred from the heating element to the temperature sensor. Therefore, in the context of the invention, the channel can also be referred to as a modulation channel.

The channel can be understood as an outlet region when the fluid flows through the channel from a front volume through the cavity of the carrier via the aperture of the membrane. Conversely, the channel can also be regarded as an inlet region when the fluid flows from a rear volume through the channel to the aperture in the direction of the cavity to a front volume.

The channel preferably exhibits dimensions in the three spatial dimensions of length, height and width. The length of the channel denotes the spatial dimension that corresponds to the direction of flow of the fluid within the thermal fluid sensor. If the direction of flow is indicated by a vector, the length of the channel is preferably present parallel to this vector to indicate the direction of flow. The height of the channel is a component orthogonal to the length and extends vertically orthogonal to the plane of the membrane. The height of the channel is determined in particular by the smallest vertical component of the flow section within the thermal fluid sensor. The smallest vertical component of the flow section or the height of the channel is the distance between the temperature sensor or heating element positioned on the membrane and the longitudinal section of the support structure located above it.

The width of the channel is a component that is perpendicular to the length and height of the channel. The width and length lie in the plane of the membrane, wherein the length corresponds to the direction of the fluid flow. In FIG. 1, the length, width and height are marked for better clarification. The acoustic resistance RS from equation (1) corresponds to the dimensions of the channel in terms of length h, width I and height w. The cross-section of the channel through which the fluid flows is calculated as the product of the width and height (as a reference section for the direction of flow of the fluid or from the perspective of the fluid).

The length of the channel is preferably between the boundary of the membrane to the aperture and the boundary of the longitudinal section above the membrane. Thus, the length of the channel can also be understood as a partial length of the support structure (preferably the longitudinal section) and the membrane. Preferably, the length of the channel lies in a range between 1 μm and 200 μm, preferably 5 μm-100 μm, or even 10 μm-50 μm. The length of the channel can be configured in particular by the length of a longitudinal section of the support structure above the membrane.

The height of the channel preferably lies in a range between 50 nm-5 μm, particularly preferably between 100 nm-5 μm, 200 nm-2 μm or even 300 nm to 1 μm. Such low channel heights can preferably be formed by a conformal sacrificial layer deposition.

The width of the channel is preferably between 1 μm-50 mm, preferably between 5 μm-10 μm or even 10 μm to 1000 μm. In the cross-sectional views of the figures below, the length and height are shown schematically (not necessarily true to scale), while the dimension of the width corresponds to a (non-visible) drawing depth of the figures. In the case of an elongated slit of an aperture, the channel will preferably also exhibit a greater width in the dimension of the drawing depth.

In a further preferred embodiment, the thermal fluid sensor is characterized in that a flow direction of the fluid is changed at least in one region when flowing through the thermal fluid sensor, wherein a change in the flow direction preferably exhibits an angle of substantially 90°. The region preferably represents a flow section for the fluid within the thermal fluid sensor.

Terms such as substantially, approximately, about, approx, etc. preferably describe a tolerance range of less than +40%, preferably less than +20%, particularly preferably less than +10%, even more preferably less than +5% and in particular less than +1% and always include the exact value. Partially describes preferably at least 5%, particularly preferably at least 10%, and in particular at least 20%, in some cases at least 40%.

Consequently, the change in flow direction can also preferably be 130°, 125°, 120°, 115°, 110°, 105°, 100°, 95°, 90°, 85°, 80°, 85°, 80°, 75°, 70°, 60°, 55° or 50°. The angle for the change in flow direction is preferably determined by the support structure, preferably by an angle that is present between a base and a longitudinal section, which preferably determine the shape and/or configuration of the support structure. In particular, it is advantageously possible to direct the fluid particularly precisely in the direction of the heat flow, which is made possible by means of the channel.

The fluid preferably flows through the aperture of the membrane and is deflected by the support structure such that the fluid flows through the channel within the flow section, wherein the heat flow between the temperature element and the heating element is preferably substantially orthogonal to the flow path of the fluid.

In a further preferred embodiment, the thermal fluid sensor is characterized in that the thermal fluid sensor is configured to measure a continuous or oscillating fluid flow, preferably of sound pressure waves.

A continuous fluid flow preferably refers to a fluid flow that exhibits instantaneous values that do not change over time. An instantaneous value refers to a value of a time-dependent variable at a given point in time. In analogy with electrical engineering, a continuous fluid flow is therefore comparable to a direct current, which is why the term DC flow can also be used to describe the continuous fluid flow. The preferred thermal fluid sensor is advantageously able to regulate the flow velocity at which the continuous fluid flow propagates by means of the size of the aperture introduced into the membrane. Thus, the flow velocity is higher if the aperture is smaller. Conversely, the flow velocity can be reduced if the aperture is larger. The aperture can therefore be used to set the flow velocity at which the fluid flows into the channel of the thermal fluid sensor. The flow velocity within the channel can also be set by the configuration of the channel itself. In particular, the cross-section of the channel, i.e. the product of height and length (see FIG. 1, w*I, wherein I denotes the dimension in the image plane), determines the flow velocity at which the fluid can pass through the heat flow. The smaller the selected cross-section, the higher the flow velocity of the fluid within the channel. If the cross-section of the channel is larger, the flow velocity can be reduced. The dimensions of the channel can in turn be determined by the support structure. As a result, the flow velocity relevant for the modulation, which is present at the point where the flow crosses the heat flow, can be set by the dimensions of the support structure.

An oscillating fluid flow preferably refers to a fluid flow that propagates in the form of a wave, resulting in a change in at least one location-dependent and time-dependent variable of the fluid. Accordingly, an oscillating fluid flow is comparable to an alternating current in analogy with electrical engineering, which is why the term AC flow can also be used to describe the oscillating fluid flow. In other words, an oscillating fluid flow propagates by means of pressure waves. Consequently, the preferred thermal fluid sensor can also be used as a microphone, since sound also propagates in the form of pressure waves or sound pressure waves. In the case of an oscillating fluid flow, an acoustic resistance and a rear volume are particularly relevant with regard to a lower cutoff frequency, as explained above. Preferably, the rear volume refers to a volume that is formed at the rear between the membrane and a cover on the carrier. Due to the possibility of setting a high acoustic resistance, the thermal fluid sensor can be advantageously designed in such a way that reliable performance is still achieved over a wide frequency bandwidth even with a small rear volume. In this respect, a high degree of miniaturization can be achieved, especially for acoustic applications.

Overall, the preferred thermal fluid sensor advantageously makes it possible to measure both continuous and oscillating fluid flows based on the modulation of the heat flow. This makes the preferred thermal fluid sensor suitable for a wide range of applications. The detection of a property of the fluid that modulates the heat flow can be carried out in particular by an electronic circuit or a computing unit.

In a further preferred embodiment, the thermal fluid sensor is characterized in that the thermal fluid sensor comprises an electronic circuit, wherein the electronic circuit is configured to control the heating element, to read out a measurement signal of the temperature sensor and/or to determine at least one property of the fluid based on the modulation of the heat flow between the temperature sensor and the heating element.

For the purposes of the invention, an electronic circuit preferably refers to a combination of individual electrical or electromechanical elements to form a functional arrangement. Preferably, the electronic circuit allows data or electrical signals to be transmitted, received and/or processed.

Preferred electronic circuits include, without limitation, an integrated circuit (IC), application specific integrated circuits (ASIC), a programmable logic device (PLD), a field programmable gate array (FPGA), a microprocessor, a microcomputer, a programmable logic controller and/or any other electronic, preferably programmable, circuit.

Preferably, the electronic circuit is configured to receive measurement data from the temperature sensor and to provide control signals or commands to the heating element to generate the heat flow.

Preferably, the electronic circuit can be configured to control the heating element as a function of the measurement data from the temperature sensor. Preferably, the electronic circuit is configured to give a command to the heating element to generate the heat flow according to a measurement of the temperature sensor, for example to increase, maintain constant or reduce the heat output.

In preferred embodiments, the electronic circuit can also be configured to process the measurement data recorded by the temperature sensor with regard to the modulation of the heat flow. The processing of data preferably means that the electronic circuit is configured to perform computational operations and/or computational steps, for example with recorded measurement data from the temperature sensor. In particular, the electronic circuit or an external data processing unit connected to it can be used to determine the difference between a base value of the heat flow and the measurement data measured at the temperature sensor.

The electronic circuit can therefore be present as an evaluation, readout and/or control electronics unit, which enables the heating element to be controlled, the temperature sensor to be read out and/or the measurement data to be evaluated. If an evaluation is carried out, the electronic circuit can also be referred to as a computing unit.

The term “computing unit” preferably refers to any device or unit that can be configured to perform computing operations. Preferably, the computing unit is, for example, a processor, a processor chip, a microprocessor and/or a microcontroller, which is preferably configured to perform an evaluation of the modulation of the heat flow. The computing unit can also preferably be a programmable circuit board. The computing unit may also preferably comprise a computer-usable or computer-readable medium, such as a hard disk, random access memory (RAM), read only memory (ROM), flash memory, etc.

Method steps for determining the properties of the fluid, as described herein, are preferably performed by the electronic circuit or computing unit. The phrase “is configured to” preferably means that a computer code and/or software is installed on the electronic circuit or computing unit in order to carry out the process step, for example in order to check the extent to which a modulation of the heat flow was caused and which parameters of the fluid were decisive for this. The computer code and/or the software for evaluating the modulation of the heat flow can be written in any programming language or a model-based development environment, e.g. in C/C++, C#, Objective-C, Java, Basic/VisualBasic, MATLAB, Simulink, StateFlow, Lab View or Assembler.

The computer code and/or the software, which is preferably installed on the electronic circuit or computing unit, in particular to carry out an evaluation of the modulation of the heat flow, can be regarded as technical features, since a direct physical effect of the thermal fluid sensor is used, for example supplying a control signal for a heating element or detecting a temperature change. Functional descriptions of the computer code and/or software can therefore be regarded as preferred and defining embodiments of the invention. The particular computer code and/or software used is available to the person skilled in the art and can be installed accordingly using standard knowledge. In a further preferred embodiment, the thermal fluid sensor is characterized in that the support structure comprises a base and a longitudinal section, wherein the base is connected to the membrane and the longitudinal section extends above the aperture. Preferably, the temperature sensor is mounted on or below the longitudinal section.

The base and the longitudinal section preferably designate sections of the support structure that determine its configuration. The base refers to the section of the support structure that extends substantially vertically. In particular, the base preferably defines the vertical displacement above the aperture of the membrane. The longitudinal section is preferably arranged substantially vertically on the base and extends at least over the aperture and preferably beyond that over the membrane or a temperature sensor or heating element attached thereto. Preferably, the temperature sensor or the heating element is arranged on or under the longitudinal section. If the heating element is located on the membrane, the temperature sensor is preferably arranged on or under the longitudinal section. If the temperature sensor is preferably located on the membrane, the heating element is located on or under the longitudinal section.

The configuration of the support structure, comprising a base and a longitudinal section, advantageously provides flexibility for the arrangement of the temperature sensor or the heating element on the support structure. The vertical positioning can be specified by means of the base. In other words, the vertical displacement between the temperature sensor and the heating element can be determined by the base. The longitudinal section makes it possible to specify the lateral positioning of the temperature sensor or the heating element. It may therefore be preferable for the temperature sensor and the heating element to be positioned vertically directly above one another without any lateral displacement. It may also be preferable for there to be a lateral displacement in addition to the vertical displacement between the temperature sensor and the heating element. Furthermore, the width of the channel can also be determined by the longitudinal section and thus also a flow section for the fluid that is substantially transverse to the heat flow of the heating element.

In a further preferred embodiment, the thermal fluid sensor is characterized in that the base exhibits a height between approx. 0.5 μm-20 μm, preferably between approx. 1 μm-10 μm, and/or the longitudinal section exhibits a length between approx. 10-1000 μm, preferably between approx. 50-800 μm, particularly preferably between approx. 50-500 μm, most preferably between approx. 50-200 μm.

The preferred dimensions for the base and/or longitudinal section have proven to be advantageous in that a flow path can be provided which entails particularly good measurement results.

In particular, the base of the support structure allows the vertical dimensions of the flow path to be defined. As a result, the base can be used to adjust the minimum vertical distance between the temperature sensor or the heating element, depending on which component is mounted on the membrane, and the longitudinal section of the support structure. Consequently, the height of the channel is less than the height of the base. The height of the base substantially corresponds to the sum of the height of the channel and a vertical component of the flow section between the channel and the aperture on the membrane. The height of the channel is preferably also influenced by the thickness or height of the longitudinal section, wherein this preferably exhibits a thickness of between 10 nm-20 μm, preferably between 100 nm-10 μm or even 1-5 μm. In particular, the height of the channel can also be adjusted by the layer thickness of the deposition of a sacrificial layer, which is present on the membrane (or on the temperature sensor and heating element) and to which the support structure is applied. After etching of the sacrificial layer, the height of the channel corresponds to the original thickness of the sacrificial layer.

The smallest vertical distance between the temperature sensor or heating element and the support structure (or the height of the channel) is decisive for the acoustic resistance (see equation (1)). A particularly high acoustic resistance can be advantageously achieved by setting a low height of the channel.

The term acoustic resistance refers in particular to the acoustic characteristic impedance or acoustic field impedance. The acoustic resistance preferably describes the resistance against the propagation of the sound and thus the pressure fluctuations. The acoustic resistance is determined by the quotient of sound pressure and sound velocity or also as the product of density and sound velocity.

Furthermore, the aforementioned preferred dimensions for the height and/or length of the support structure have proven to be advantageous in that cross-sections are configured in order to optimize the modulation as such, in particular by regulating the flow velocity at the point of intersection with the heat flow. This means that the sensitivity of the thermal fluid sensor can be optimized for a wide range of applications.

Furthermore, the height between the temperature sensor or heating element on the membrane and the support structure can be regulated by the dimensions of the base. In combination with the dimensions of the base, a sacrificial layer, which is attached to the carrier, can also influence the height between the temperature sensor or heating element on the membrane and the support structure. The lowest height or the lowest vertical component of the channel is preferably present between the temperature sensor or heating element and the support structure. The lowest height is preferably between approx. 50 nm-5 μm, preferably between approx. 300 nm-1 μm.

The support structure therefore makes it possible to determine the dimensions of the channel vertically (height) and laterally (length and width). The width of the channel is preferably orthogonal to the height and orthogonal to the direction of propagation of the fluid within the channel in the direction of the heat flow (see FIG. 1, corresponds to component z in the image plane). The preferred dimensions are between 1 μm-50 000 μm, preferably 5 μm-10 000 μm or even 10 μm-1000 μm.

The length of the longitudinal section is substantially the sum of the length of the aperture of the membrane and the length of the channel. Consequently, the preferred specifications for the length of the longitudinal section are suitable for the placement of a plurality of temperature sensors and/or heating elements in order to enable a more intensive heat transfer and/or a highly accurate measurement, depending on the application.

The preferred dimensions with regard to the longitudinal section and/or base have also proven to be advantageous such that sufficient stability of the support structure is ensured. The support structure is not impaired by the fluid flowing through the channel, such that a long-lasting functionality of the measurement is guaranteed. In particular, vibrations are advantageously avoided, ensuring a high degree of reliability for the measurement of the fluid properties.

In a further preferred embodiment, the thermal fluid sensor is characterized in that at least one opening is present, preferably a plurality of openings, below the temperature sensor or the heating element on the support structure, preferably on a longitudinal section, wherein the at least one opening is preferably circular, elliptical, triangular, square, polygonal or slit-shaped.

Advantageously, the opening enables better transfer of the heat flow from the heating element to the temperature sensor. Without the opening, the material of the support structure, which forms the longitudinal section, is present. The heat flow can therefore be transferred more effectively depending on the thermal conductivity of the material of the support structure. An opening below the temperature sensor or heating element can further improve direct heat transfer between the two components, enabling extremely precise temperature measurements to be taken with little energy input.

In a further preferred embodiment of the thermal fluid sensor, it may be preferable to provide a region with a reduced layer thickness and/or a material with increased thermal conductivity below the temperature sensor or the heating element on the support structure, preferably on a longitudinal section. These embodiments can also improve the transfer of the heat flow from the heating element to the temperature sensor.

For example, the layer thickness of the longitudinal section in a region below the temperature sensor or heating element can be reduced by 20%, 30%, 40%, 50% or more in order to ensure more efficient heat transfer. It may also be preferable to use a material with increased thermal conductivity in a region that facilitates heat transfer. Preferably, a material with increased thermal conductivity means a material that exhibits a higher thermal conductivity than the base material of the support structure. Preferably, the thermally conductive material can, for example, exhibit a thermal conductivity of more than 200 W/(m K), more than 300 W/(m K) or more than 400 W/(m K), where W/(m K) corresponds to the unit watt per meter and Kelvin. Examples of thermally conductive materials include silver, copper, gold and/or aluminum.

In this respect, in the aforementioned embodiments, it is preferable to provide a region below the heating element or temperature sensor which is characterized by a material composition and/or thickness that differs from the rest of the support structure, whereby the transfer of the heat flow is supported. With regard to the shape of the region, the above remarks apply to various conceivable shapes of the openings. The dimension is preferably adapted to the size of the heating element or temperature sensor, wherein in preferred embodiments a maximum dimension is less than 50 μm, preferably less than 40 μm, 30 μm, 20 μm, 10 μm or 5 μm.

In a further preferred embodiment, the thermal fluid sensor is characterized in that the support structure comprises a material selected from a group comprising polysilicon, silicon nitride and/or silicon dioxide.

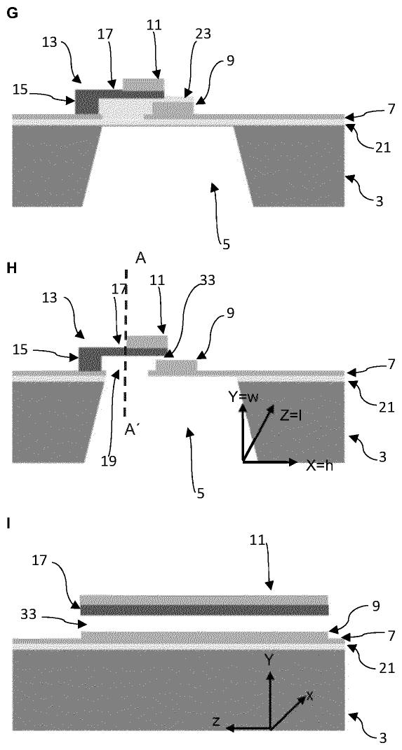

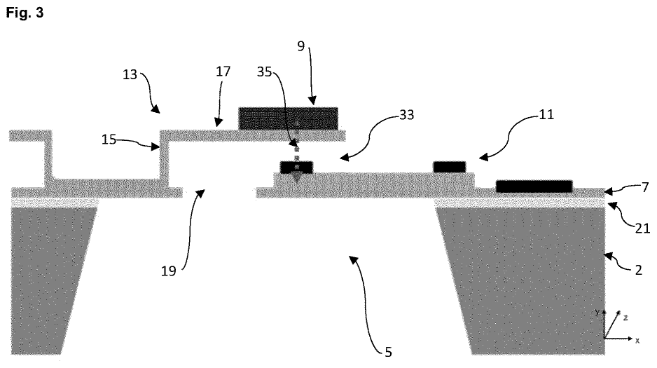

The preferred materials have proven to be particularly advantageous for possible losses that could occur due to the effect of heat conduction. In particular, the preferred materials for the support structure are characterized on the one hand by a sufficiently low thermal conductivity, in order to support the function of the support structure in reducing material-bound heat conduction from the heating element to the temperature sensor. Furthermore, possible measurement noise is reduced, which could be caused by heat transfer via the membrane and support structure. Instead, the heat is substantially transferred by convection through the fluid to be analyzed. On the other hand, the materials are not too insulating, so as to prevent heat transfer through the layer thickness, for example of a longitudinal section of the support structure on which a heating element is located (see FIG. 3). As explained above, in preferred embodiments, for example, regions of an opening or reduced layer thickness can be provided to support heat transfer. With the aforementioned materials, in particular with a thickness of the longitudinal section of less than 100 μm, preferably less than 50 μm, particularly preferably less than 10 μm, most preferably less than 5 μm, good transfer can be ensured even without such regions.

In addition, the preferred materials can be processed using prior art semiconductor and microsystems technology processes to provide the support structure.

In a further preferred embodiment, the thermal fluid sensor is characterized in that the support structure comprises a material which exhibits a thermal conductivity between 0.1-40 W/(m*K), preferably between 1-30 W/(m*K).

The aforementioned thermal conductivities are sufficiently low to keep losses due to thermal conduction of the material of the support structure low or to minimize them, such that an optimal measurement of the heat flow through the temperature sensor can be made possible.

In a further preferred embodiment, the thermal fluid sensor is characterized in that the vertical distance between the heating element and the temperature sensor is in a range of approx. 100 nm-10 μm, preferably approx. 100 nm-1 μm.

The vertical distance between the temperature sensor and the heating element is preferably the sum of the height of the channel and the thickness of the longitudinal section on which the temperature sensor or the heating element is located.

The preferred distance ranges with regard to the vertical displacement have proven to be advantageous in that they allow particularly reliable temperature detection by the temperature sensor by means of convection. In particular, it is possible to achieve substantially targeted convection to the temperature sensor without the heat flow having to accept losses for the temperature measurement. This improves the accuracy and sensitivity of the heat flow measurement and the modulation of the heat flow. The preferred vertical distance ranges also have a positive effect on the efficiency of the operation of the preferred thermal fluid sensor, as the energy requirement can be reduced due to the proximity of the heating element and temperature sensor.

In a further preferred embodiment, the thermal fluid sensor is characterized in that there is no lateral displacement between the heating element and the temperature sensor, such that preferably the heating element and the temperature sensor exhibit a maximum lateral overlap or there is a lateral displacement, preferably the heating element and the temperature sensor exhibit a partial overlap or the heating element and the temperature sensor exhibit no partial overlap but are laterally spaced apart.

In other words, a maximum lateral overlap (no lateral displacement), a lateral partial overlap or a lateral spacing may preferably be present between the heating element and the temperature sensor.

In a further embodiment, the thermal fluid sensor is characterized in that there is a lateral displacement between the heating element and the temperature sensor, preferably the lateral displacement is in a range of 1 μm-20 μm or there is no lateral displacement or a lateral displacement of at most 1 μm between the heating element and the temperature sensor.

The lateral displacement preferably characterizes a displacement orthogonal to the vertical displacement, preferably along a longitudinal section of the support structure or, with respect to the fluid flow, along the path of the fluid flowing in the channel. The lateral displacement preferably comprises a displacement along a length (but can also be along a width). The vertical and lateral displacement between the components is preferably determined by the geometric center of the active regions, for example the geometric center of a heating structure and/or sensor. In the case of a thermopile, the active region preferably corresponds to the hot end.

The sensitivity of the thermal fluid sensor can be adjusted by a lateral displacement between the temperature sensor and the heating element in combination with a vertical displacement. In a preferred embodiment, the heating element and the temperature sensor are substantially vertically directly above each other, without a lateral displacement. In this case, the path of the heat flow, i.e. the heat path, is reduced to a minimum, such that potential losses of the heat flow are reduced or avoided. The heat path can be extended by an additional lateral displacement (in addition to the vertical displacement). It is advantageous that the longitudinal section of the support structure and thus also the channel can be configured with reduced dimensions, but an extended heat path is still possible. The preferred thermal fluid sensor therefore makes it possible to configure both the dimensions of the channel for a flow section of the fluid, for example by setting a height or cross-section as explained above, and the heat path independently of this.

The lateral displacement thus advantageously provides a further degree of freedom that can be used to influence the modulation of the heat flow. Depending on the application, the flow velocity of the fluid in the channel and the heat path between the temperature sensor and heating element can therefore be optimized independently of each other in order to measure the properties of the fluid.

For this purpose, it may be preferable to have a vertical displacement and a lateral displacement, wherein there is no lateral overlap between the temperature sensor and the heating element. In this case, the temperature sensor and heating element are therefore laterally displaced. Furthermore, it may be preferred that there is a vertical displacement and a lateral displacement, wherein there is a partial lateral overlap between the temperature element and the heating element. In a lateral plane of the two components, there can therefore preferably be a lateral displacement, in the sense of a lateral offset, in which there is still a partial overlap between the temperature element and the heating element. It may also be preferable for there to be only a vertical offset, with a substantially complete lateral overlap between the temperature sensor and heating element. In this case, there is therefore preferably no lateral offset between the two components, instead the overlap is maximum, in preferred embodiments 100%.

For this purpose, it is preferred that the temperature sensor or the heating element is located on the support structure, preferably on or under the longitudinal section, and the corresponding other component is located on the membrane.

In a further preferred embodiment, the thermal fluid sensor is characterized in that the membrane is held by a carrier, wherein the carrier preferably exhibits a cavity which is located below the aperture of the membrane.

The carrier is preferably a frame structure, which is substantially formed by a continuous outer border in the form of lateral walls of a free flat region. The frame structure is preferably stable and rigid. In the case of an angular frame shape (triangular, square, hexagonal or generally polygonal outline), the individual lateral regions, which preferably substantially form the frame structure, are referred to in particular as lateral walls.

The membrane is preferably held by at least two lateral walls of the carrier. Preferably, the carrier preferably comprises four lateral walls on which the membrane is mounted. Preferably, the membrane is suspended flat within the free area. The planar extension of the membrane indicates a lateral direction of the thermal fluid sensor. The membrane is preferably present above the cavity of the carrier.

The planar configuration of the membrane preferably means that dimensions such as a length and/or width are many times greater than a height or thickness orthogonal thereto. Thus, the length and/or width can be higher than the thickness by a factor of 1.5, 2, 5, 10, 100, 1,000, 10,000 or more. Preferably, the thickness of the membrane is between 0.1-1000 μm, preferably between 0.5-500 μm, particularly preferably between 1-300 μm, most preferably between 5-200 μm.

The membrane is preferably configured in such a way that any vibrations caused by the flow of the fluid do not occur. Accordingly, the membrane is sufficiently stable for the measurement result not to be distorted by the modulation of the heat flow.

Preferably, in addition to the aperture, the membrane can exhibit one or more structures that are arranged perpendicular to the heating element. For example, a grid structure, comprising bars that are arranged in series and offset from one another, may be present on the membrane. This can advantageously reduce or avoid parasitic heat conduction in the membrane.

In a further preferred embodiment, the thermal fluid sensor is characterized in that the membrane comprises a material selected from a group comprising silicon nitride, silicon dioxide, polyimide and/or porous silicon.

The preferred materials for the membrane have proven to be advantageous in that, in addition to their excellent capacity for configuration as a membrane, they also provide thermal insulation, such that heat conduction caused by the membrane is reduced or avoided. This further improves the accuracy of the measurement results. The preferred material for the membrane can be silicon nitride, for example, which has proven to be particularly advantageous in terms of processing, stability and thermal insulation.

In a further preferred embodiment, the thermal fluid sensor is characterized in that the aperture exhibits a shape selected from a group comprising circular, elliptical, triangular, quadrangular, pentagonal, hexagonal, heptagonal, octagonal or polygonal, wherein the aperture preferably exhibits an area of between 1 μm²-10 000 μm², preferably between 1 μm²-1000 μm² or also 10 μm²-100 μm².

The preferred configuration of the aperture allows a reliable ingress of the fluid into the preferred channel of the flow sensor without having to accept flow losses.

Particularly preferably, the aperture applied to the membrane exhibits a shape that corresponds to a cross-section of the channel, enabling an efficient passage of the fluid from the aperture into the flow section to the channel. The cross-section of the channel, which is determined by the length and width, directly adjoins the flow section. For a channel in the form of a slit, for example with a width (in the drawing depth in the figures below) of more than 100 μm or more than 1 mm, the aperture will preferably also be in the form of a slit. Likewise, it may also be preferred to incorporate a plurality of apertures in the membrane, which are arranged along the channel.

In a further preferred embodiment, the thermal fluid sensor is characterized in that the heating element is an electrical heating element, preferably a heating resistor, wherein preferably the heating element comprises a material selected from a group comprising silicon, polysilicon, aluminum, copper, gold, platinum, nickel, silver and/or tungsten, wherein preferably, as a semiconductor material, the material exhibits a doping.

The heating element preferably refers to the component of the thermal fluid sensor from which the heat flow emanates by means of an emission of thermal energy. An electrical heating element preferably refers to a heating element that is capable of converting electrical energy into thermal energy, which in the context of the invention is used as a heat flow and transferred to the temperature sensor. The thermal energy or the heat flow is preferably generated by an electric heating element in such a way that an electrically conductive material is used through which an electric current flows and which is heated by Joule heat.

The preferred materials for the heating element, in particular for the electric heating element, advantageously permit a particularly high temperature without causing melting processes and/or chemical reactions (such as oxidation) of the heating element and/or other components. Furthermore, the preferred materials exhibit a high specific resistance such that the heating element can have a particularly compact design. Doping in the case of a semiconductor allows better electrical conductivity and therefore also better heat supply and convection from the heating element.

In a further preferred embodiment, the thermal fluid sensor is characterized in that the temperature sensor is selected from a group comprising a thermocouple, a diode, a thermopile or a thermistor.

The temperature sensor is preferably the component of the thermal fluid sensor that is able to measure the heat flow, in particular the modulation of the heat flow through the fluid.

A thermistor preferably refers to a component comprising an electrical resistance whose value changes reproducibly with the temperature. Thermistors are divided into NTC thermistors and PTC thermistors in terms of their temperature behavior. An NTC thermistor exhibits a negative temperature coefficient and can conduct electrical current better in a hot state than in a cold state. A PTC thermistor exhibits a positive temperature coefficient and can conduct electricity better in a cold state than in a hot state.

In another preferred embodiment, the thermal fluid sensor is characterized in that the temperature sensor is a thermistor, wherein the thermistor is located on a section of the support structure, preferably on a longitudinal section, or on the membrane.

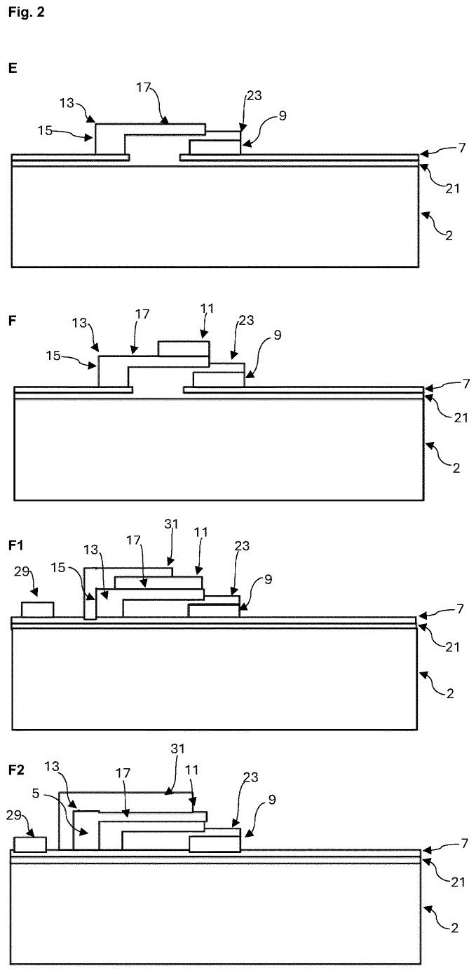

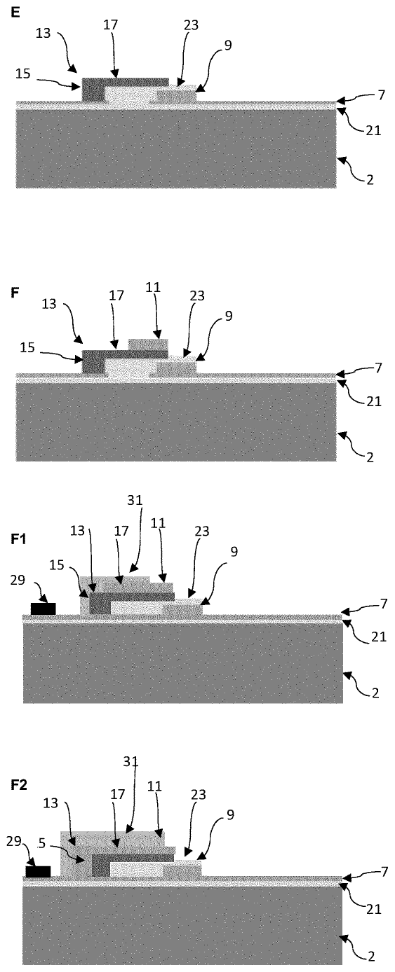

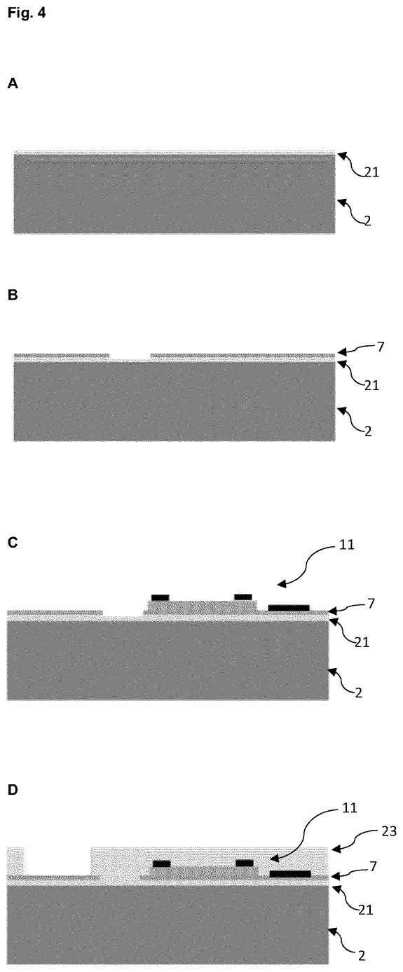

By means of a thermistor, it is possible to draw conclusions about a modulation of the heat flow and therefore properties of the flowing fluid in a simple and precise manner on the basis of a changing electrical resistance. In addition, the provision of a thermistor can be particularly easily integrated into a process for producing the fluid sensor (see FIGS. 2, 4).

A thermocouple preferably refers to an arrangement comprising a pair of electrically conductive materials that are connected to each other at one end and allow conclusions to be drawn about the measured temperature due to the thermoelectric effect. Electrical energy is provided in the event of a temperature difference along the arrangement. A thermopile refers to an element that exhibits a plurality of thermocouples. The thermocouples of the thermopile are preferably electrically connected in series and thermally connected in parallel.

The temperature sensor can preferably be operated using a Wheatstone bridge circuit (also Wheatstone bridge). A Wheatstone bridge is used to measure the temperature, whereby the voltage can be measured and related to the resistance of a thermistor, for example.

The Wheatstone bridge can be configured in different modes, for example in constant temperature (CT) mode. In this case, the heating element is preferably controlled for constant heat output to the temperature sensor. Furthermore, the Wheatstone bridge can also be configured in such a way that a constant temperature difference (CTD) is detected, for example between two sections of the temperature sensor to detect the heat flow. The latter is particularly preferred with a thermocouple as the temperature sensor.

The measuring point of the thermocouple or thermopile is referred to as the hot end or hot junction and forms one end of a thermocouple. The other end, which is analogously referred to as the cold end or cold junction, designates a reference junction that serves as a reference in order to detect the temperature difference. Preferably, an electronic circuit and/or a computing unit for processing the temperature measurement is connected to the cold junction. A Wheatstone bridge in CTD mode can detect the temperature between the hot end and the cold end so that parameters can be inferred from the effect of the fluid on the heat flow.

In a further preferred embodiment, the thermal fluid sensor is characterized in that the temperature sensor is a thermocouple or thermopile comprising a hot junction and a cold junction, wherein the hot junction is preferably located on a section of the support structure, preferably on a longitudinal section.

The cold junction can preferably also be located on the support structure. Preferably, however, the cold junction is located outside the support structure, preferably on the membrane or the carrier. If the cold junction is located on a carrier material with high thermal conductivity, for example, the carrier material (e.g. silicon with a high thermal conductivity of 150 W/(m*K)) can serve as a heat sink so that a temperature difference can occur within the thermocouple or the thermopile, which can be used to detect the heat transfer from the heating element to the temperature sensor with particular sensitivity.

A diode can also function advantageously as a temperature sensor. For example, it is possible here to make use of the fact that the forward voltage of a diode changes substantially linearly with the temperature. The higher the temperature, the lower the forward voltage and vice versa. Accordingly, the change in forward voltage can be used to draw conclusions about a change in temperature.

In a further preferred embodiment, the temperature sensor, preferably the thermocouple or the thermopile, is mounted on the membrane. Accordingly, the heating element is preferably located on the support structure, preferably on or under the longitudinal section of the support structure. It may be preferred that the thermocouple or the thermopile is located as a temperature sensor on an intermediate layer which is attached to the membrane (see FIG. 3). The intermediate layer can preferably exhibit electrical lines that enable temperature measurement through the hot junction and cold junction. In particular, the intermediate layer acts as a thermal insulation layer so that potential temperature losses due to heat conduction from the membrane are reduced or avoided.

For the purposes of the invention, the phrase a heating element or a temperature sensor means in particular at least one heating element or at least one temperature sensor, wherein preferably two, three, four or more heating elements or two, three, four or more temperature sensors can also be provided.

In a further preferred embodiment, the thermal fluid sensor comprises at least two temperature sensors, wherein a combination signal of the at least two temperature sensors, preferably a differential signal, is formed to measure an oscillating fluid flow, preferably caused by sound pressure waves.

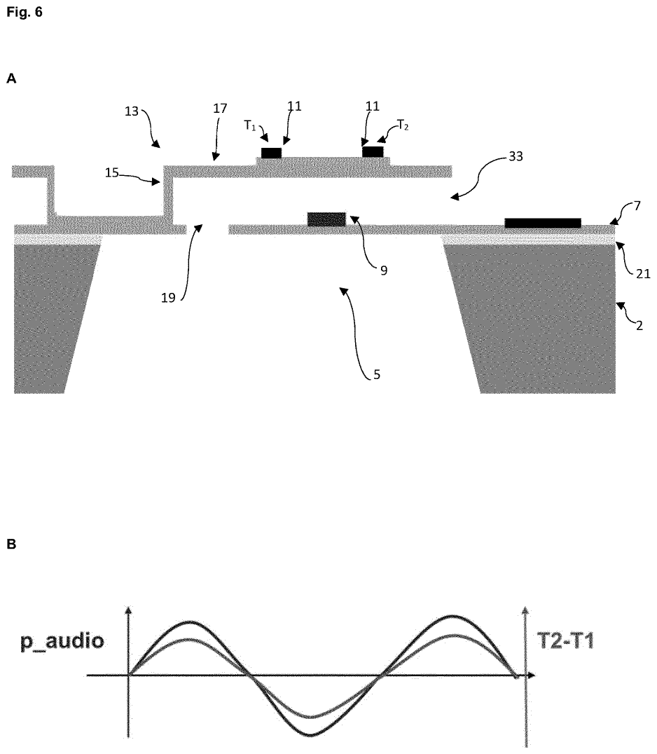

The at least two temperature sensors can, for example, be present as two ends of a thermocouple. However, they can also be provided by at least two independent temperature sensors. In preferred embodiments, the at least two temperature sensors are located on the support structure, preferably a longitudinal section of the support structure, wherein the heating element is attached to the membrane (see FIG. 6A). A reverse arrangement is also conceivable, wherein the at least two temperature sensors preferably are mounted on the membrane and the (at least one) heating element is mounted on the support structure, preferably on a longitudinal section of the support structure.

By providing two temperature sensors for measuring a first temperature measurement value T₁ and a second temperature measurement value T₂, a combination signal can be formed. The combination signal can, for example, relate to a difference between the two measured values T₂-T₁. Advantageously, by forming the combination signal, preferably a differential signal, a measurement signal can be obtained which is substantially in phase with an oscillating fluid flow that flows through the thermal fluid sensor (see FIG. 6B). Particularly with regard to the measurement of sound pressure waves, the formation of a phase-true measurement signal proves to be advantageous for improving the measurement quality.

In a further aspect, the invention relates to a method for producing a preferred thermal fluid sensor comprising the following steps:
a) providing a carrier substrate,
b) applying a membrane to the carrier substrate starting from a front side, optionally by application of a first sacrificial layer,
c) structuring of the membrane to provide an aperture,
d) attaching a heating element or temperature sensor to the membrane,
e) application of the support structure to the membrane, optionally by application of a second sacrificial layer,
f) application of a temperature sensor or heating element to the support structure,
g) etching the carrier substrate starting from a rear side to provide a cavity and to obtain a carrier such that the aperture overlies the cavity and the membrane is held by the carrier,
h) providing a channel, optionally etching sacrificial layers.

The average person skilled in the art will recognize that technical features, definitions and advantages of preferred embodiments of the described thermal fluid sensor also apply to the preferred method for producing the thermal fluid sensor, and vice versa.

Preferably, the described production method serves to provide a thermal fluid sensor which exhibits a support structure such that at least one vertical displacement is present between the temperature sensor and the heating element.

For this purpose, it is preferred to first provide a carrier substrate. The carrier substrate refers to a substrate that later acts as a carrier for the membrane. This means that the carrier substrate is preferably restructured into a carrier in the course of the preferred method. The carrier substrate may, for example, comprise a material selected from a group comprising monosilicon, polysilicon, silicon dioxide, silicon carbide, silicon germanium, silicon nitride, nitride, germanium, carbon, gallium arsenide, gallium nitride, indium phosphide and/or glass.

A membrane is then preferably applied to the carrier substrate starting from a front side. It may be preferred to first apply a sacrificial layer to the carrier substrate. A membrane is then coated onto the sacrificial layer. Silicon, silicon oxide, silicon nitride and/or polyimide are preferably used as the material for the membrane. The membrane can preferably be applied already structured or structured after its coating, such that the subsequent aperture is present as an interruption within the membrane.

For coating components and/or materials of the preferred thermal fluid sensor, one or more coating processes can be used selected from a group comprising spray coating, mist coating, vapor coating, physical vapor deposition (PVD), chemical vapor deposition (CVD), low pressure chemical vapor deposition (LPCVD), plasma-enhanced chemical vapor deposition (PECVD), epitaxial coating, sputtering and/or atomic layer deposition.

It is then preferred to apply a heating element (or a temperature sensor) to the membrane. When using a first sacrificial layer, it is preferred that the heating element or temperature sensor is applied to the first sacrificial layer.

In a preferred embodiment, the heating element is applied to the membrane.

Preferably, a support structure is provided after the heating element (or a temperature sensor) has been applied to the membrane. For this purpose, it may be preferred to apply a second sacrificial layer which covers both the aperture of the membrane and the heating element. The layer thickness of the second sacrificial layer over the subsequent aperture preferably defines the height of the base of the subsequently applied support structure. The layer thickness of the second sacrificial layer over the heating element (or the temperature sensor) preferably defines the height of the subsequently obtained channel.

The support structure is preferably coated on the second sacrificial layer, wherein the support structure preferably exhibits a base and a longitudinal section which extends at least over the aperture of the membrane. The length of the longitudinal section preferably defines the length of a flow section in the direction of flow, which protrudes over the membrane and temperature sensor (or heating element).

After the support structure has been attached, the temperature sensor (or the heating element) is preferably attached to the support structure, preferably on or under the longitudinal section. It is understood that a corresponding component of the temperature sensor and heating element pair is always attached to the support structure and membrane. If the temperature sensor has been attached to the membrane, the heating element is attached to the support structure and vice versa.

Preferably, if the temperature sensor is attached to the support structure, particularly in the case of a thermopile, further optional intermediate steps can preferably be carried out. For example, a metal layer can be used to make contact with a contact pad. The metal layer can, for example, extend along the base and the temperature sensor. Alternatively, the metal layer can extend along the temperature sensor, which is applied to the base and the longitudinal section.

The carrier substrate can then be etched starting from a rear side. For this purpose, one or more etching processes known from the prior art selected from a group comprising wet chemical etching processes and/or dry etching processes, preferably physical and/or chemical dry etching processes, particularly preferably by reactive ion etching and/or reactive ion deep etching (Bosch process) can be used.

The etching provides the cavity and thus the carrier, such that the aperture of the membrane lies above the cavity and the membrane is held by the carrier. Furthermore, the first and/or the second sacrificial layer is preferably etched to provide the channel of the thermal fluid sensor.

In a further preferred embodiment, a temperature sensor, in particular a thermocouple, is applied to the membrane. For this purpose, the hot junction and the cold junction are preferably present on an intermediate layer, which is present as a thermal insulator layer. This further reduces or eliminates heat conduction through the material enabling the modulation of the heat flow to be measured with increased precision.

It may then be preferred to apply a second sacrificial layer and structure this. The support structure is applied to the second sacrificial layer. The height of the base of the support structure can be determined by the layer thickness of the second sacrificial layer. The layer thickness of the second sacrificial layer over the heating element (or the temperature sensor) preferably defines the height of the subsequently obtained channel. This is then also preferably structured. The dimensions of the longitudinal section of the support structure can be determined in particular by structuring the support structure.

Once the support structure has been structured, the heating element is preferably arranged on the support structure, in particular on the longitudinal section. Then, preferably, etching can be carried out on the rear side in order to provide the cavity on the carrier substrate and thus also the carrier for the membrane. The first and/or second sacrificial layer can be etched thereon in order to provide the channel. Through the channel, the fluid can flow through the heat flow such that the properties of the fluid can be inferred from the modulation of the heat flow as described.

Optionally, it may be preferable to attach a cover to the carrier. The cover provides a rear volume such that the support structure, the heating element and the temperature sensor are located within the rear volume. The attachment of the cover is particularly preferred in the context of use as a microphone.

In a further aspect, the invention relates to a use of a preferred thermal fluid sensor for measuring one or more properties of a fluid, preferably a flow parameter, pressure fluctuations, preferably acoustic pressure waves, the composition and/or concentration of a fluid.

Flow parameters can, for example, be selected from a group comprising flow velocity, pressure and/or temperature of the fluid.

Typically, the higher the flow parameter, the greater the modulation of the heat flow. With regard to the temperature, the higher the temperature deviation between the temperature of the fluid and that of the heat flow, the greater the modulation of the heat flow.

The pressure and therefore also pressure fluctuations of the fluid flowing through the heat flow can also be measured. The higher the pressure or pressure fluctuations, the greater the modulation of the heat flow. As pressure fluctuations are characteristic of sound waves, it is also possible to detect sound pressure waves using the preferred thermal fluid sensor. This means that the preferred thermal fluid sensor can also be used as a sound detector or microphone.

Therefore, in a further preferred embodiment, the invention also relates to a sound detector or microphone comprising a sound inlet opening and an electronic circuit, wherein oscillations of a fluid in the form of sound waves pass through the sound inlet opening and an electrical signal can be generated as a function of the sound waves, characterized in that the microphone exhibits a temperature sensor, a heating element and a support structure, wherein the support structure extends at least partially across the aperture at a vertical distance from a membrane, wherein the temperature sensor or the heating element is mounted on the support structure and the electronic circuit is configured to measure the sound waves based on the modulation of a heat flow between the heating element and the temperature sensor.

The average person skilled in the art will recognize that technical features, definitions and advantages of preferred embodiments of the described thermal fluid sensor also apply to the preferred microphone or sound detector, and vice versa.

Preferably, the microphone exhibits a cover. The cover is preferably attached to the carrier and encloses the parts of the membrane, the support structure, the heating element and the temperature sensor within a rear volume. Thus, the rear volume preferably refers to a spatial section provided by the cover and, in particular, is present between the membrane and the cover.

Advantageously, a particularly small rear volume can be made possible, which is of particular benefit with regard to miniaturization. Furthermore, the low height of the channel at the point of intersection with the heat flow allows a low acoustic resistance to be set.

In a preferred embodiment, the microphone is provided in a bottom port configuration. In this case, the sound inlet opening corresponds to the aperture on the membrane, which is located on the carrier. The sound propagates through the cavity through the aperture, flows through the channel and exerts a modulation on the heat flow between the heating element and the temperature sensor and propagates further in the direction of the rear volume and/or the rear-side volume. However, the microphone can also be provided in a top-bottom configuration.

Advantageously, the preferred thermal fluid sensor enables measurements with a high bandwidth. In particular, an upper cutoff frequency can be determined by a thermal capacity of the temperature sensor or a thermal resistance of the membrane. By providing a miniaturized fluid sensor or temperature sensor and a thermally insulating support structure, a high upper cutoff frequency can be advantageously ensured. In particular, a lower cutoff frequency can be determined by the configuration of the channel. The provision of a support structure to form a channel with any low height desired advantageously allows a low lower cutoff frequency, with a compact structure at the same time, meaning that a thermal MEMS microphone with a high dynamic range can be advantageously provided by means of the proposed structure.

A composition and/or concentration of the fluid flowing through the heat flow can also be measured using the preferred thermal fluid sensor. This can be done in particular by using the fluid sensor as a photoacoustic gas sensor, preferably when the thermal fluid sensor is used as a microphone.

In the case of a photoacoustic gas sensor, intensity-modulated radiation is preferably used with frequencies in the absorption spectrum of the molecule to be detected in the fluid. If this molecule is present in the beam path, modulated absorption takes place, which leads to heating and cooling processes whose time scales reflect the modulation frequency of the radiation. The heating and cooling processes lead to expansion and contraction of the fluid, causing sound waves with the modulation frequency. These can enter the preferred thermal fluid sensor, which can measure the sound waves based on the modulation of the heat flow. Thus, in a further aspect, the invention relates to a photoacoustic sensor comprising a preferred thermal fluid sensor.

In a further preferred embodiment, the invention thus relates to a photoacoustic gas sensor comprising a modulatable emitter, a detection chamber which can be filled with gas and a reference chamber, wherein a thermal fluid sensor described herein is present between the detection chamber and the reference chamber in terms of flow and wherein the detection chamber is preferably arranged in the beam path of the emitter, such that the emitter can excite gas in the detection chamber to form sound pressure by means of modulatably emittable radiation and equalization of the sound pressure through the aperture in the membrane into the reference chamber can be detected by means of the preferred thermal fluid sensor. Preferably, the membrane to which the aperture is applied serves as a gas-tight separation between the detection chamber and the reference chamber. The aperture enables a gas flow between the detection chamber and the reference chamber, wherein the support structure provides a channel as described, which enables particularly reliable measurements.

The radiation modulated with a modulation frequency preferably impinges on the detection chamber. If the modulated radiation is emitted with a wavelength that corresponds to the absorption spectrum of a molecule of a gas component in the gas mixture, modulated absorption takes place, which leads to heating and cooling processes whose time scales reflect the modulation frequency of the radiation. According to the photoacoustic effect, the heating and cooling processes lead to expansions and contractions of the gas component, whereby the gas component is induced to form sound pressure waves with substantially the modulation frequency. The sound pressure waves can be measured as a gas flow through the aperture by means of the thermal fluid sensor based on the modulation of the heat flow between the heating element and the temperature sensor. Advantageously, this enables fast and reliable detection of a PAS signal (photoacoustic spectroscopy signal). The modulation of the heat transport by the gas flow is advantageously a particularly sensitive gage for determining the PAS signals, which can be optimized in particular by optimizing the dimensions of the aperture, the channel and/or by selecting the temperature sensor and/or the heating element.

### FIGURES

In the following, the invention will be explained in more detail with reference to figures, without being limited to these.

### BRIEF DESCRIPTION OF THE FIGURES

FIG. 1 Schematic representation of a preferred embodiment of the thermal fluid sensor according to the invention

FIG. 2 Illustration of preferred steps of a method for producing a preferred thermal fluid sensor

FIG. 3 Schematic representation of a further preferred embodiment of the thermal fluid sensor

FIG. 4 Illustration of preferred steps of a method for producing a preferred thermal fluid sensor

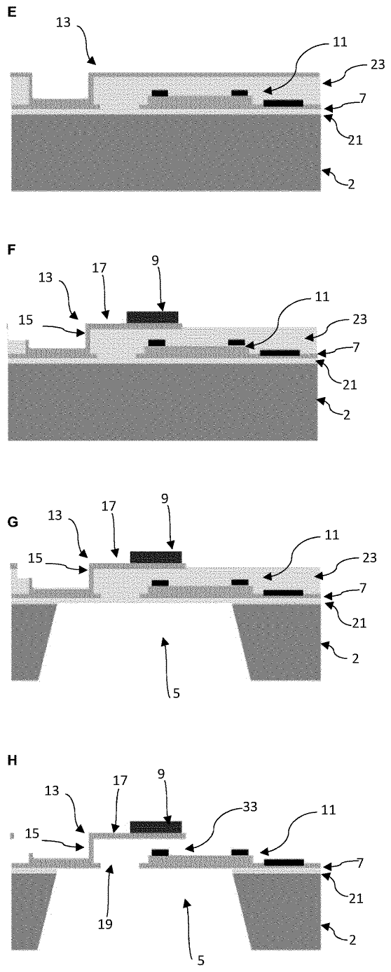

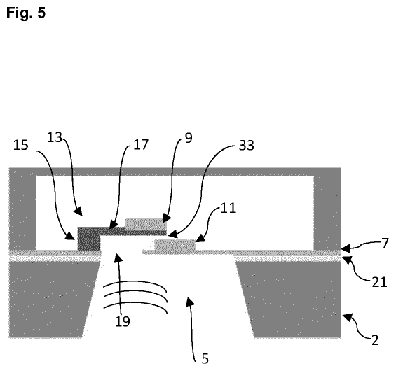

FIG. 5 Schematic representation of a preferred embodiment of the thermal fluid sensor as a MEMS microphone

FIG. 6 Schematic representation of a further preferred embodiment of the thermal fluid sensor

### DETAILED DESCRIPTION OF THE FIGURES

FIG. 1 is a schematic representation of a preferred embodiment of a thermal fluid sensor 1 according to the invention.

The thermal fluid sensor 1 exhibits a membrane 7 with an aperture 19 as well as a heating element 9 and a temperature sensor 11. These are positioned in such a way that at least one property of a fluid flowing through the aperture 19 can be measured based on the modulation of a heat flow between the heating element 9 and the temperature sensor 11. The thermal fluid sensor exhibits a support structure 13, which extends at least partially over the aperture 19 at a vertical distance from the membrane 7.

In the illustration according to FIG. 1, the temperature sensor 11 is mounted on the support structure. Accordingly, the heating element 9 is mounted on the membrane 7. A reverse arrangement with the heating element on the support structure and the temperature sensor on the membrane is also possible.

Advantageously, using the thermal fluid sensor 1, it is possible to effectively reduce measurement noise. With thermal fluid sensors known from the prior art, the arrangement of the temperature sensor and heating element on or along a plane can entail a not insignificant heat transfer due to material-bound heat conduction. However, the sensitivity of the thermal fluid sensor 1 is based on heat transfer by convection via the fluid to be analyzed, which flows between the temperature sensor and heating element. Thus, the heat transfer by convection is advantageously dependent on the properties of the fluid to be analyzed, such that conclusions can be drawn about, for example, flow parameters, pressure fluctuation(s), the composition and/or concentration of the fluid on the basis of a modulation of the heat transfer.

Heat conduction in the plane, for example via a membrane on which the temperature sensor and the heating element are arranged, disadvantageously entails a heat transfer that is not dependent on the properties of the fluid to be analyzed. Changes in the thermal conductivity of the membrane or other materials or components of the sensor therefore lead to heat modulation between the temperature sensor and the heating element, which is not dependent on the properties of the fluid, but is reflected in the measurement results as noise.

The disadvantageous noise is eliminated by reducing heat conduction in the plane between the heating element 9 and the temperature sensor 11 by placing the heating element 9 or the temperature sensor 11 on a support structure 13 and thus providing a vertical displacement between the heating element 9 and the temperature sensor 11.

This ensures that heat is transferred through a heat path 35 from the heating element 9 to the temperature sensor 11 substantially by convection via the fluid to be analyzed. The heat modulation therefore reflects properties of the fluid to be analyzed (flow parameters, pressure fluctuation, heat conduction, etc.). Noise caused by material-bound heat conduction that is independent of the properties of the fluid is advantageously reduced.

A further advantage of the thermal fluid sensor 1 is that it enables a particularly controlled modulation of the heat flow which is transferred from the heating element 9 to the temperature sensor 11. The support structure 13, which extends at least partially at a vertical distance over the aperture 19 of the membrane 7, allows a particularly small cross-section to be achieved in the form of a channel 33 for directing the flow of the fluid through the thermal fluid sensor. The modulation of the heat flow is independent of the configuration of the channel. However, the support structure 13 and in particular the channel 33 advantageously make it possible to set a fluidic resistance (or acoustic resistance) for the fluid flowing through the heat flow. Thus, advantageously, a desired measurement sensitivity or acoustic properties of the thermal fluid sensor 1 can be easily set. Advantageously, it is also possible to easily amplify a signal by attaching a plurality of temperature sensors.

The channel 33, which represents a spatial section within which the heat flow is modulated by the fluid, is located within a flow section provided by the support structure 13.

Advantageously, the configuration of the support structure 13 allows the height of the channel 33 to be set to almost any desired level. The height of the channel 33 preferably refers to the lowest height or lowest vertical extent of the channel 33 within the thermal fluid sensor, which is preferably present between a heating element 9 installed on the membrane 7 and the support structure 13 extending above it.

The thermal fluid sensor 1 thus offers the possibility of detecting particularly accurate measurement results with a compact design. The higher accuracy and thus also the higher resolution results, among other things, from higher flow velocities of the fluid through the heat flow, which can be made possible by the configuration of the support structure 13 or of a channel 33 with a low height. In particular, even very small pressure differences can be detected in this way.

Furthermore, a high acoustic resistance can be set for dynamic measurements of pressure fluctuations by a low height of the channel 33, whereby a lower lower cutoff frequency can be ensured even with relatively small rear volumes. As explained at the beginning, the lower cutoff frequency is determined in particular by the acoustic or fluidic resistance, the capacitance and the rear volume (see equation (3)). The provision of a support structure 13 to form a channel 33 with any desired low height advantageously permits a low lower cutoff frequency with a compact structure at the same time.

Furthermore, a close arrangement between the temperature sensor 11 and the heating element 9 can be achieved, which enables energy-saving operation of the thermal fluid sensor 1.

FIG. 2 shows a schematic representation of preferred steps for producing a preferred thermal fluid sensor 1, preferably the embodiment shown in FIG. 1.

FIG. 2A shows a carrier substrate 2, which is provided and to which a first sacrificial layer 21 is applied.

FIG. 2 B shows the coating of the membrane 7, which is applied to the first sacrificial layer 21. In FIG. 2 B it can be seen that this is structured, which serves to provide the aperture on the membrane 7. The shape and/or dimensions of the aperture can be determined by the structuring.

FIG. 2 C shows the attachment of a heating element 9 to the membrane 7 by means of a coating process and optional structuring of the heating element 9.

FIG. 2 D shows the coating of a second sacrificial layer 25, which can also be structured. The second sacrificial layer 25 can cover both the aperture 19 of the membrane 7 and the heating element 9. The layer thickness of the second sacrificial layer 25 above that of the structuring for the subsequent aperture defines the height of the base of the subsequently applied support structure. The layer thickness of the second sacrificial layer 25 over the heating element 9 defines the height of the subsequently obtained channel.

The support structure 13 is applied to the membrane 7 on the second sacrificial layer 25, as also illustrated in FIG. 2 E. The base 15 is located on the membrane, while the longitudinal section extends along the second sacrificial layer 23. The length of the longitudinal section defines the length of a flow section in the direction of flow, which overlaps the membrane and temperature sensor (or heating element).

FIG. 2 F shows that the temperature sensor 11 (or the heating element) is applied to the support structure 13, which can also be done by a coating process and an optional structuring.

An optional intermediate step is shown in FIGS. 2 F1 and 2 F2. This can be particularly useful if a thermopile is used as a temperature sensor 11 and coated onto the support structure 13. In FIG. 2 F1 it can be seen that a metal layer 31 is used to make contact with a contact pad 29. The metal layer 31 extends along the base 15 and the temperature sensor 11. As shown in FIG. 2 F2, the metal layer 31 can alternatively extend along the temperature sensor 11, which is applied to the base 15 and the longitudinal section 17.

FIG. 2 G serves to illustrate the etching of the carrier substrate 2 starting from a rear side to provide a cavity 5 and to obtain a carrier 3, such that the aperture 19 lies over the cavity 5 and the membrane 7 is held by the carrier 3. One or more etching processes known in the prior art selected from a group comprising wet chemical etching processes and/or dry etching processes, physical and/or chemical dry etching processes, reactive ion etching and/or reactive ion deep etching (Bosch process) can be used for this purpose. Etching provides the cavity 5 and thus the support 3, such that the aperture 19 of the membrane 7 lies above the cavity 5 and the membrane is held by the carrier.

Then, as shown in FIG. 2 H, a channel is provided in which the first sacrificial layer 23 and the second sacrificial layer 25 are etched such that the fluid can flow through the channel to modulate the heat flow.

FIG. 2 I shows a close-up view of the cross-section A-A′ from FIG. 2 H and illustrates that the narrowest point or the smallest distance is between the support structure 13 and the heating element 9. The narrowest point corresponds to the height of the channel from equation (1).

FIG. 3 schematically shows a further embodiment of the thermal fluid sensor 1 according to the invention.

The thermal fluid sensor 1 exhibits the membrane 7 with the aperture 19. Here too, the heating element 9 and the temperature sensor 11 are positioned in such a way that at least one property of a fluid flowing through the aperture can be measured. The thermal fluid sensor 1 comprises a support structure 13, which extends at least partially over the aperture 19 at a vertical distance from the membrane 7. In the preferred embodiment shown in FIG. 3, the heating element is present on the support structure 13, in particular on the longitudinal section 17. Accordingly, the temperature sensor 11 is arranged on the membrane. The membrane 7 lies on the first sacrificial layer 21, which is located on the carrier 3.

The temperature sensor 11 is present in the form of a thermocouple comprising a hot junction and a cold junction. The thermocouple 11 is located on an intermediate layer, which is attached to the membrane 7. The intermediate layer acts as a thermal insulation layer so that possible temperature losses due to heat conduction from the membrane 7 are reduced or avoided.

FIG. 4 schematically illustrates preferred steps for producing a preferred thermal fluid sensor 1, preferably the embodiment according to FIG. 3.

FIG. 4A shows the provision of the carrier substrate 2 to which the first sacrificial layer 21 is applied.

FIG. 4 B shows the application of the membrane 7 to the carrier substrate 2 starting from the front side, wherein the membrane 7 is applied to the first sacrificial layer 21. The membrane 7 is structured to provide the aperture 19 for the thermal fluid sensor.

FIG. 4 C serves to illustrate the application of the temperature sensor 11 to the membrane 7. In the embodiment shown in FIG. 4 C, the temperature sensor 11 is a thermocouple 11. Here, a hot junction and cold junction are present on an intermediate layer, which acts as a thermal insulator layer. This makes it possible to reduce material-dependent heat conduction such that the modulation of the heat flow is substantially dependent on the fluid properties to be measured.

FIG. 4 D shows that the second sacrificial layer 23 is applied and structured. The structuring is carried out in order to apply a partial section of the support structure to the membrane 7 in the subsequent step.

FIG. 4 E shows the application of the support structure 13 to the membrane 7, wherein a partial section of the support structure 13 extends along the second sacrificial layer 23.

FIG. 4 F shows that the heating element 9 is applied to the support structure 13, wherein the support structure is structured, in particular for the configuration of the longitudinal section 17 of the support structure 13.

Then, as shown in FIG. 4 G, the carrier substrate 2 is etched starting from the rear side, such that a cavity 5 and the carrier 3 are obtained. The aperture 19 is thus located above the cavity 5 on the membrane 7, which is held by the carrier 3.

Finally, the channel is provided by etching the first sacrificial layer 21 and second sacrificial layer 23. Through the channel, the fluid can flow through the heat flow emanating from the heating element 9 to cause modulation such that a property of the fluid can be measured.

FIG. 5 illustrates a preferred embodiment of the thermal fluid sensor as a MEMS microphone. For this purpose, a cover 25 is attached to the carrier 3. A rear volume 27 is provided by the cover 25. This means that the support structure 13, the heating element 9 and the temperature sensor 11 are located within the rear volume 27. The lines drawn in illustrate sound waves that can modulate the heat flow. The attachment of the cover 27 is particularly useful in the context of use as a microphone to protect components from environmental influences and to form a rear volume. Due to the possibility of providing a high acoustic resistance, the rear volume can advantageously be kept particularly small, so that a compact thermal fluid sensor or microphone with a relatively wide frequency bandwidth can be produced.

FIG. 6A shows a further embodiment of the thermal fluid sensor. The thermal fluid sensor exhibits two temperature sensors 11. In the embodiment shown, the temperature sensors 11 are present in the form of two ends of a thermocouple. However, they can also be provided by two independent temperature sensors. The two temperature sensors 11 are located on the longitudinal section 17 of the support structure 13. Accordingly, the heating element 9 is mounted on the membrane 7. A reverse arrangement is also conceivable.

By providing two temperature sensors, a temperature measurement can advantageously be carried out on two sections of the thermal fluid sensor. A first measured temperature value T₁ is recorded at a first temperature sensor 11 and a second measured temperature value T₂ at a second temperature sensor 11. A combination signal can be formed by recording the first measured temperature value T₁ and the second measured temperature value. The combination signal can, for example, be formed via the difference between the two measured values T₂−T₁. Advantageously, by forming the combination signal (here as a differential signal), a measurement signal can be obtained that is substantially in phase with an oscillating fluid flow that flows through the thermal fluid sensor. A substantially in-phase signal has proven to be advantageous for a particularly precise determination of at least one fluid property, in particular with regard to the measurement of sound pressure waves.

FIG. 6 B schematically illustrates the phase equivalence of the sound pressure (p_audio), which flows through the thermal fluid sensor as an oscillating current, compared to the differential signal T₂−T₁.

### LIST OF REFERENCE SYMBOLS

1 Thermal fluid sensor
2 Carrier substrate
3 Carrier
5 Cavity
7 Membrane
9 Heating element
11 Temperature sensor
13 Support structure
15 Base
17 Longitudinal section
19 Aperture
21 First sacrificial layer
23 Second sacrificial layer
25 Cover
27 Rear volume
29 Contact pad
31 Metal layer
33 Channel
35 Heat path

### BIBLIOGRAPHY

Kuo, Jonathan T W, Lawrence Yu, and Ellis Meng. “Micromachined thermal flow sensors-A review.” Micromachines 3.3 (2012): 550-573.
Xu, Xiang-Yuan, et al. “A monolithic three-dimensional thermal convective acoustic vector sensor with acoustic-transparent heat sink.” JASA Express Letters 2.4 (2022): 044001.
Lauwers, Thomas, Alain Glière, and Skandar Basrour. “An all-optical photoacoustic sensor for the detection of trace gas.” Sensors 20.14 (2020): 3967.
Balakrishnan, Vivekananthan, et al. “Thermal flow sensors for harsh environments.” Sensors 17.9 (2017): 2061.

1. A thermal fluid sensor comprising a membrane having an aperture, a heating element and a temperature sensor positioned such that at least one property of a fluid flowing through the aperture is measurable based on the modulation of a heat flow between the heating element and the temperature sensor, wherein the thermal fluid sensor exhibits a support structure which extends at least partially over the aperture at a vertical distance from the membrane, wherein the temperature sensor or the heating element is mounted on the support structure.

2. The thermal fluid sensor according to claim 1, wherein the at least one property of the fluid flowing through the aperture, which can be measured based on the modulation of a heat flow between the heating element and the temperature sensor, is a flow parameter, a pressure fluctuation, the composition and/or concentration of the fluid.

3. The thermal fluid sensor according to claim 1, wherein a channel is formed between the heating element and the temperature sensor by a section of the support structure and the membrane, wherein a flow path for the fluid can be provided through the channel.

4. The thermal fluid sensor according to claim 1, wherein a flow direction of the fluid is changed at least in one region when flowing through the thermal fluid sensor.

5. The thermal fluid sensor according to claim 1, wherein the thermal fluid sensor is adapted to measure a continuous or oscillating fluid flow.

6. The thermal fluid sensor according to claim 1, wherein the thermal fluid sensor exhibits an electronic circuit, wherein the electronic circuit is configured to control the heating element, to read out a measurement signal of the temperature sensor and/or to determine at least one property of the fluid based on the modulation of the heat flow between the temperature sensor and the heating element.

7. The thermal fluid sensor according to claim 1, wherein the support structure exhibits a base and a longitudinal section, wherein the base is connected to the membrane, the longitudinal section extends above the aperture and the temperature sensor is mounted on or below the longitudinal section.

8. The thermal fluid sensor according to claim 1, wherein below the temperature sensor or heating element on the support structure, a region is present which is characterized by a material composition and/or thickness that differs from the rest of the support structure in order to support a transfer of the heat flow.

9. The thermal fluid sensor according to claim 1, wherein the vertical distance between the heating element and the temperature sensor is in a range of 100 nm-10 μm.

10. The thermal fluid sensor according to claim 1, wherein no lateral displacement is present between the heating element and the temperature sensor.

11. The thermal fluid sensor according to claim 1, wherein the membrane is held by a carrier.

12. The thermal fluid sensor according to claim 1, wherein the temperature sensor is selected from a group comprising a thermocouple, a diode, a thermopile or a thermistor.

13. The thermal fluid sensor according to claim 1, wherein the thermal fluid sensor comprises at least two temperature sensors and a combination signal of the at least two temperature sensors is formed for measuring an oscillating fluid flow.

14. A method for producing a thermal fluid sensor according to claim 1, comprising the following steps:
providing a carrier substrate,
applying a membrane starting from a front side onto the carrier substrate, optionally with application of a first sacrificial layer,
structuring the membrane to provide an aperture,
attaching a heating element or temperature sensor to the membrane,
applying the support structure to the membrane, optionally with application of a second sacrificial layer,
attaching a temperature sensor or heating element to the support structure,
etching the carrier substrate starting from a rear side to provide a cavity and to obtain a carrier such that the aperture lies over the cavity and the membrane is held by the carrier, and
providing a channel, optionally etching sacrificial layers.

15. A method of measuring one or more properties of a fluid, the composition of the fluid and/or a concentration of fluid, the method comprising measuring the fluid with the thermal fluid sensor according to claim 1.

16. The thermal fluid sensor according to claim 3, wherein the channel exhibits a height of 50 nm-5 μm.

17. The thermal fluid sensor according to claim 4, wherein the change in the flow direction exhibits an angle of substantially 90°.

18. The thermal fluid sensor according to claim 5, wherein the continuous or oscillating fluid flow is caused by sound pressure waves.

19. The thermal fluid sensor according to claim 8, wherein the region is on a longitudinal section.

20. The thermal fluid sensor according to claim 10, wherein the heating element and the temperature sensor exhibit a maximum lateral overlap or a lateral displacement is present, or wherein the heating element and the temperature sensor exhibit a partial overlap or wherein the heating element and the temperature sensor exhibit no partial overlap but are laterally spaced apart.

21. The thermal fluid sensor according to claim 11, wherein the carrier exhibits a cavity which is located below the aperture of the membrane.

22. The thermal fluid sensor according to claim 12, wherein the temperature sensor (11) is a thermistor, wherein the thermistor is located on a section of the support structure.

23. The thermal fluid sensor according to claim 13, wherein the combination signal of the at least two temperature sensors is a differential signal caused by sound pressure waves.
